(19) United States
(12) Patent Application Publication
(10) Pub. No.: US 2005/0154609 A1
(43) Pub. Date: Jul. 14, 2005

(54) Method of controlled imparting of ethical content cartoons to selected audience with feedback

(76) Inventor: Clinton A. Kurtz, Renton, WA (US)

Correspondence Address: David L. Garrison, Suite 3300, 2001 Sixth Avenue, Seattle, WA, 98121-2522, US

(21) Appl. No.: 10/997,322

(22) Filed: Nov. 24, 2004

Related U.S. Application Data
(60) Provisional application No. 60/524,477, filed on Nov. 24, 2003.

(51) Int. Cl. G06F 17/60

(52) U.S. Cl. 705/1

(57) ABSTRACT

A series of cartoon drawings depicting ethical and unethical behavior in an organization which has an impact on the financial results of said organization. The purpose of the cartoon's messages would be to improve the actions of people so that the organization's financial reporting would more accurately reflect the actual results of the entity. It is also likely that the actual financial results of the organization entity would be greater if this invention were routinely utilized throughout the organization. This cartoon could be distributed in printed form or electronically.

### TECHNICAL FIELD

The invention relates to a method using a series of paper or electronic cartoon drawings depicting ethical and unethical behavior by people in an organization which impacts the financial results of said organization to encourage and instill ethical behavior in a group of professional persons or a group of members of the society having an affinity factor. The present invention further relates to improving the behavior of people in the accounting firms, business companies, and governmental agencies resulting in improved financial reporting of the entities financial activities. Also it provides a method to enhance the image of the accounting profession, business companies and governmental agencies and provide for possible generate revenue by marketing said invention outside of the organization.

### BACKGROUND OF THE INVENTION

The accounting profession has tarnished its reputation from time to time due to the ongoing financial reporting problems that companies have created and which have been exposed.

Much of the effort to stop this behavior has been directed at the accounting profession to catch the improprieties via the rules and regulations that the CPA industry develops along with legislative efforts such as the Sarbanes-Oxley Act. These methods do not focus enough on avoiding the problem but more on treating the problem after it has occurred. This is somewhat like a doctor treating the symptoms and ignoring the real cause of the illness.

So, what is the real problem? The problem is unethical behavior by people, primarily employees of governmental agencies, public companies, companies need to forecast future earnings, the auditor's lack of client independence, and the CPA firm's internal pressure to generate increasing profits.

Having the right “moral or ethical compass” routinely reinforced throughout an organization from top to bottom should reduce the unethical behavior that has become more visible and expensive to accounting firms, their clients, and client stockholders. What would it have been worth if the issues at Enron had been stopped before or shortly after they started? Arthur Andersen would still be in business and the shareholders of Enron would definitely be in better shape.

### SUMMARY OF THE INVENTION

The invention would apply to accounting firms, businesses, and governmental agencies and constitutes the use of a series of cartoons to routinely focus on the ethical and unethical choices that people are exposed to each day in the business environment. The purpose of the cartoon series' message would be to improve the actions of people so that the organization's financial reporting more accurately reflects the actual results of the entity. It is also likely that the actual financial results of the organization entity would be greater if this invention were routinely utilized throughout the organization.

Businesses and governmental agencies could use this invention independent of the accounting firms.

The cartoon series would be distributed in printed or electronic form.

### DISCLOSURE OF THE INVENTION

An example of how the invention could be utilized from the perspective of the accounting firms is as follows:

1. Focus a portion of resources (money and time) to correct the behavior of the accounting firm's people and the people who are employees (broadly defined to include all who the company employs) within their client companies. It needn't be limited to those who are involved with the financial decision making and financial reporting of the companies. Everyone throughout an organization should to be involved. Imagine the benefit if every employee knew the warning signs of unethical/poor accounting practices and could challenge those employees who are heading down the wrong path.

2. People are overwhelmed today with all the information that comes their way during the day. A good, concise means of developing problem awareness and then providing reasonable steps that people can take when they are involved or aware of a problem situation is needed. The best way of accomplishing this is using a cartoon as the vehicle for communicating the message for the following reasons:
a. A picture is worth a thousand words.
b. Daily cartoons are quick and easy to read.
c. The message is relatively easy to understand.
d. Cartoons have the ability to be easily shared via posting on the office refrigerator, the bulletin board, or via email.
e. A message targeted at what good and bad behavior looks like will positively influence the behavior of the people who read the cartoon series on a regular basis. Regular reinforcing what good behavior looks and sounds like and avoiding bad behavior is needed to influence people's behavior in the long run.

The cartoon should be from one to multiple scenes with the fewest scenes being the most likely to be read by people in a hurry.

4. The cartoon could be distributed as follows:
a. Using an interactive web presentation for staff to view first thing in the morning when they log on to the computer network would be a good way to make it part of the daily routine. They have a simple situation and a couple of outcomes to choose from. One being more ethical than the other(s). Documenting this process would be relatively easy and would show that the company is helping its employees understand what better organizational behavior is.
b. Email to accounting staff
c. Requiring audited clients to require their employees to use an interactive web presentation for staff to view first thing in the morning when they log on to the computer network would be a good way to make it part of the daily routine. They have a simple situation and a couple of outcomes to choose from. One being more ethical than the other(s). Documenting this process would be relatively easy and would show that the company is helping its employees understand what better organizational behavior is.
d. Email to clients
e. Newsletter
f. Newspaper, probably in the business section.
g. Business publications such as magazines.
h. Accounting firm's web site location that can be accessed by clients, staff, outsiders and which they could view “XYZ's—Our Daily Choices” (one possible name for the cartoon, or perhaps “XYZ's—Moral Compass” or “XYZ's—A day at the office”, etc.). XYZ being the initials of the accounting firm.

5. Access to previous day(s) cartoon strips should be available by requesting printed copies or electronically they should be retrievable.

6. A record of the employees having viewed the cartoon strip(s) is something an entity may want to document to show compliance with its staff in this area of ethical training. An entity could also tabulate the choices made by the employee to determine if the employee is selecting the expected behavior. The tabulation could be employee specific or simply group all employees' results so the individual choices are anonymous.

7. The frequency of the cartoon could be daily, weekly, or monthly. Daily would have a better chance of improving peoples behavior.

8. Developing good and bad client cartoon characters over time allows the message to stay current and yet develop into messages that would remain applicable over time. Finding good in clients could be brought out as a means of improving the bad behavior in clients.

9. Having the message be fun and interesting would enhance the likelihood that it actually helps improve behavior in people. Having the right the right verbal message of the cartoon series is critical to its short and long term success. Allowing for ideas to come from the employees or users of the invention would also be a source of new material for the cartoon strips.

10. Using a company website to host the cartoon series would enable the organization to tailor the cartoon strip(s) the employees review to be employee specific. As an example: Employee A logs into the website and for Employee A the site brings up the “General ethical/non ethical cartoon strip, the “Auditing” cartoon strip, and the “Banking” cartoon strip. Employee B logs into the website and for Employee B the site brings up the “General” ethical/non ethical cartoon strip and the “Tax preparers” cartoon strip.

11. Using a company website as in item 10 above could be developed to allow clients and subscribers to log into the one site and depending on the log in procedure, the client or subscriber employees would have specific cartoon strips that their employees to view.

Advantages to an accounting firm to be at the forefront of this positive action include but are not limited to the following:

1. Developing an “XYZ character/s in the cartoon that would portray the firm in a realistic (and perhaps not always perfect) light. There could be multiple characters from XYZ . . . A “Partner”, “Supervisor”, and “Staff” person. Being the first accounting firm to use this invention would really spotlight the firm and build name recognition for XYZ.

2. If this concept was something that was picked up by the newspapers as a regular cartoon series, imagine the positive publicity XYZ could get around the country/world. What is it worth to a firm to be in the Wall Street Journal every day? XYZ becomes the firm that helps people in real life situations. It is likely the cartoon series would generate revenue.

3. This would show clients and the industry that XYZ is a proactive accounting firm that focuses on removing problems before they become big expensive disasters.

4. Improve the public image of the accounting firm.

5. The cost of developing this cartoon series is relatively low.

6. Once implemented the invention should also help the accounting firm's bottom line with fewer lawsuits as accounting professionals and clients behavior improves.

The cartoon series can be focused on various levels of people in business and this may require various focused cartoon series:

1. When used within XYZ, as a means of improving common sense, ethical behavior and accountability, it would be a message targeted at what good and bad behavior looks like inside the accounting firm. You would probably want a separate cartoon theme to be used internally with typical audit issues. Another could focus on tax department issues. These could take on focus at various levels . . . one just for partners, a different one for the entire audit department and then one for the tax department.

2. As a means of helping your public clients and also privately held clients. One message could be general, and then one for a specific industry such as banking, mutual funds, energy, etc. so you could focus on their unique issues. The Board of Directors, Audit Committees, etc. would be other groups that should be targeted.

It is a challenge getting people to attend classes, retain the concepts, and change their behavior. The people designing the messages and the cartoon figures should have the ability to focus on real world situations (could be from XYZ's, or other accounting firms past situations) and then good hypothetical situations such as:
1. “Doing the right thing is not always the easiest”
2. “Saying . . . No to cooking the books”
3. “We need to build a cookie jar”
4. “We need some sand in the budget”
5. “What's wrong with a FLPWP . . . free lunch program with profit”
6. “I deserve to take this home because I'm not paid what I'm worth”
7. “No one will know if we . . . ”
8. “We've got to meet the bank's covenants”
9. “We need to meet our Wall Street targets”
10. Etc. Etc.

These situations could be developed for the CEO, manager, secretary, truck driver levels, etc. This would keep the cartoon series fed with plenty of real life situations that relate to all levels in a company. XYZ's cartoon dialog to these situations could come from the point of view of the auditor, the tax preparer, or just from good accounting practices. The variations of the concept are many.

The public (governmental) sector would be another potential market that this invention would apply to. It has its own unique issues relating to responsibility to taxpayers, voters, conflicts of interest, etc. “It's in the budget so we need to spend it before the end of the fiscal year”, “We'll just raise taxes a little and no one will notice” are but two examples.

### BRIEF DESCRIPTION OF THE DRAWINGS

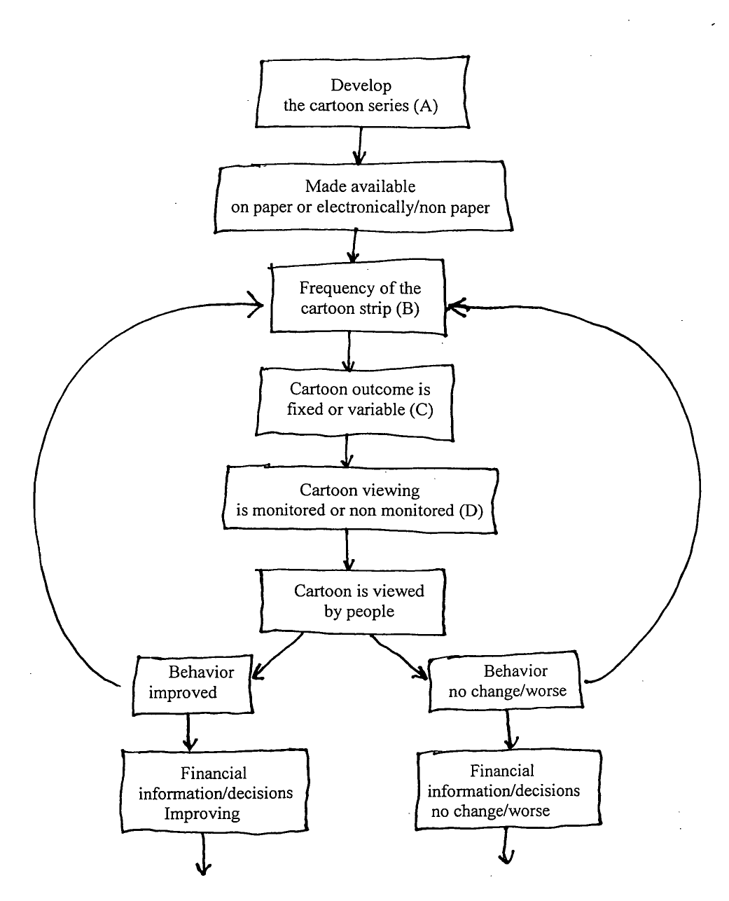

FIG. 1 is a typical flow diagram useful in the conduct of this invention in which the content laden cartoons are presented in a structured format to an identified group of viewers with provision for feedback to insure comprehension and compliance with the requirements for periodic viewing set up by the purveyor of the invention. In FIG. 1 the following conventions are included:
(a) Input comes from outside the organization or from inside the firm. The cartoon design is either by the firm or contracted out.
(b) Daily, weekly, semimonthly, monthly etc.
(c) The organization decides if their employees are going to have a choice of which outcome is more desirable for the organization or if the outcome of the cartoon is fixed.
(d) The organization decides if their employees viewing of the cartoon is to be recorded (such as Employee A viewed cartoon strip I on Oct. 20, 2003). The organization also decides if the outcome of the cartoon was a choice made by the employee which outcome the employee chose (such as Employee A viewed cartoon strip 1 on Oct. 20, 2003 and selected the preferred option); this option also has a sub option which is to keep track of this information without identifying the Employee specifically.

### INDUSTRIAL APPLICABILITY

This invention is applicable to discrete groupings of individuals in our society to instill ethical behavior and insure that the members of the group have viewed and comprehend the periodic cartoon offerings.

1. A method of instilling ethical content to observers comprising the steps of:
a. Preparing cartoon frame or a series of frames having ethical content;
b. providing said cartoon frames in an accessible format for viewers on a computer network, said computer network being programed to monitor use by individual viewers, to preclude further use of the individual computer workstation without viewing of said cartoon frames and to provide feedback from said viewers responsive to said cartoon frames;
c. monitoring use by individuals to insure viewing on a periodical basis.
